(19) United States
(12) Patent Application Publication
(10) Pub. No.: US 2001/0049742 A1
(43) Pub. Date: Dec. 6, 2001

(54) Low order channel flow control for an interleaved multiblock resource

(76) Inventors: Simon C. Steely JR., Hudson, NH (US); Hari Krishan Nagpal, Framingham, MA (US); Stephen R. Van Doren, Northborough, MA (US)

Correspondence Address: CESARI AND MCKENNA, LLP, 88 BLACK FALCON AVENUE, BOSTON, MA, 02210, US

(21) Appl. No.: 09/867,111

(22) Filed: May 29, 2001

Related U.S. Application Data
(60) Provisional application No. 60/208,439, filed on May 31, 2000.
(60) Provisional application No. 60/208,231, filed on May 31, 2000.
(60) Provisional application No. 60/208,440, filed on May 31, 2000.
(60) Provisional application No. 60/208,208, filed on May 31, 2000.

(51) Int. Cl. G06F 15/16

(52) U.S. Cl. 709/232; 709/203

(57) ABSTRACT

A flow control technique prevents overflow of a write storage structure, such as a first-in, first-out (FIFO) queue, in a centralized Duplicate Tag store arrangement of a multiprocessor system that includes a plurality of nodes interconnected by a central switch. Each node comprises a plurality of processors with associated caches and memories interconnected by a local switch. Each node further comprises a Duplicate Tag (DTAG) store that contains information about the state of data relative to all processors of a node. The DTAG comprises the write FIFO which has a limited number of entries. Flow control logic in the local switch keeps track of when those entries may be occupied to avoid overflowing the FIFO.

### CROSS-REFERENCE TO RELATED APPLICATIONS

The present application claims priority from the following U.S. Provisional Pat. App.:

Ser. No. 60/208,439, which was filed on May 31, 2000, by Stephen Van Doren, Hari Nagpal and Simon Steely, Jr. for a LOW ORDER CHANNEL FLOW CONTROL FOR AN INTERLEAVED MULTIBLOCK RESOURCE;

Ser. No. 60/208,231, which was filed on May 31, 2000, by Stephen Van Doren, Simon Steely, Jr., Madhumitra Sharma and Gregory Tierney for a CREDIT-BASED FLOW CONTROL TECHNIQUE IN A MODULAR MULTIPROCESSOR SYSTEM;

Ser. No. 60/208,440, which was filed on May 31, 2000, by Hari K. Nagpal, Simon C. Steely, Jr. and Stephen R. Van Doren for a PARTITIONED AND INTERLEAVED DUPLICATE TAG STORE; and

Ser. No. 60/208,208, filed on May 31, 2000, by Stephen R. Van Doren, Hari K. Nagpal and Simon C. Steely, Jr. for a CENTRALIZED MULTIPROCESSOR DUPLICATE TAG,

each of which is hereby incorporated by reference.

### BACKGROUND OF THE INVENTION

1. Field of the Invention

The present invention relates generally to multiprocessor computer systems and, in particular, to flow control in a Duplicate Tag store of a cache-coherent, multiprocessor computer system.

2. Background Information

In large, high performance, multiprocessor servers, many resources are shared between the multiple processors. When possible, all such resources are designed such that they can support a maximum bandwidth load that the multiple processors can demand of the system. In some cases, however, it is not practical or cost effective to design a system component to support rare peak bandwidth loads that can occur in the presence of certain pathological system traffic conditions. Components that cannot support maximum system bandwidth under all conditions require complimentary flow control mechanisms that disallow the pathological traffic patterns that result in peak bandwidth.

Flow control mechanisms that are used in support of system components that cannot support maximum system bandwidth should be designed in a most unobtrusive manner. In particular, these mechanisms should be designed such that (i) the set of conditions that trigger the flow control mechanism is not so general that the flow control mechanism is triggered so frequently that it significantly degrades average system bandwidth, (ii) if the flow control mechanism may impact varied types of system traffic, wherein each type of traffic may have a disparate impact on system performance, the mechanism should impact only traffic types that have minimal impact on the system performance, and (iii) if the flow control mechanism is protecting a component with multiple subcomponents, only the required subcomponents should be impacted by the flow control scheme.

Prior system designs have solved the problem of supporting maximum bandwidth loads using “brute” force methods. For example, a single bus system, such as the AS8400 system manufactured by Compaq Computer Corporation of Houston, Texas, stalls the entire system bus when its Duplicate Tag store nears overflow. The Duplicate Tag store is provided to buffer a low bandwidth processor cache from (probe) traffic provided by a higher bandwidth system interconnect, such as the system bus. In certain traffic situations, this brute force method may impact system performance.

If the Duplicate Tag store cannot support back-to-back references to the same block such as in, e.g., a multi-ordering point, multi-virtual channel system, logic is needed to flow control any or all of the virtual channels when a memory block conflict arises in the Duplicate Tag. Each access to the Duplicate Tag typically results in performance of two operations (e.g., a read operation and a write operation) to determine the state of a particular data block. That is, the current state of the data block is retrieved from the Duplicate Tag store and, as a result of a memory reference request, the next state of the data block is determined and loaded into the Duplicate Tag store.

In order to achieve high bandwidth Duplicate Tag access, a storage structure, such as a queue, may be provided in the Duplicate Tag for temporarily storing the write operations directed to updating the states of the Duplicate Tag store locations. This organization of the Duplicate Tag enables the read operations to efficiently execute in order to retrieve the current state of a data block and thus not impede the performance of the system. However, the write operations loaded into the write queue may “build up” and eventually overflow depending upon the read operation activity directed to the Duplicate Tag store. The present invention is directed to a technique for preventing overflow of the write queue in the Duplicate Tag.

### SUMMARY OF THE INVENTION

The present invention comprises a flow control technique for preventing overflow of a write storage structure, such as a first-in, first-out (FIFO) queue, in a centralized Duplicate Tag store arrangement of a multiprocessor system that includes a plurality of nodes interconnected by a central switch. Each node comprises a plurality of processors with associated caches and memories interconnected by a local switch. Each node further comprises a directory and Duplicate Tag (DTAG) store, wherein the DTAG contains information about the state of data relative to all processors of a node and the directory contains information about the state of data relative to the other nodes of the system.

The DTAG comprises control logic coupled to a random access memory (RAM) array and the write FIFO. The write FIFO has a limited number of entries and, as described further herein, flow control logic in the local switch keeps track of when those entries may be occupied to avoid overflowing the FIFO. The RAM array is organized into a plurality of DTAG blocks that store cache coherency state information for data stored in the memories of the node. Notably, each DTAG block maps to two interleaved banks of memory. The control logic retrieves the cache coherency state information from the array for a data block addressed by a memory reference request and makes a determination as to the current state of the data block, along with the next state of that data block.

In response to a memory reference request issued by a processor of the node, lookup operations are performed in parallel to both the directory and DTAG in order to determine where a block of data is located within the multiprocessor system. As a result, each node is organized to provide high bandwidth access to the DTAG, which further enables many DTAG lookup operations to occur in parallel. Each access to the DTAG store results in the performance of two operations (e.g., a read operation and a write operation) to determine the state of a particular data block. That is, the current state of the data block is retrieved from the DTAG and, as a result of the memory reference request, the next state of the data block is determined and loaded into the DTAG.

According to the flow control technique, a logic circuit is provided that observes traffic over a bus coupled to the DTAG, wherein the bus traffic may comprise transactions from up to five virtual channels. The logic circuit determines, for each “inter-leaved” DTAG block, whether a particular memory reference will, to a reasonable and deterministic level of approximation, require a DTAG block access. Based upon this determination, the logic circuit further determines when a particular DTAG block is in jeopardy of overflowing and, in response, averts overflow by discontinuing issuance to the bus of only the lowest order of virtual channel transactions that address only the DTAG block in jeopardy.

The present invention improves upon previous solutions in that (a) the flow control mechanism is triggered in only very rare conditions (b) it impacts only those transactions in the lowest order of virtual channel, and (c) it flow controls only those low order transactions that target one of sixteen interleaved resources. Collectively, these properties indicate that the inventive flow control mechanism has little or no impact on system performance, while protecting the system against failure in pathological traffic patterns.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes interconnected by a hierarchical switch (HS);

FIG. 2 is a schematic block diagram of a QBB node coupled to the SMP system of FIG. 1;

FIG. 3 is a schematic block diagram illustrating the interaction between a local switch, memories and a centralized Duplicate Tag (DTAG) arrangement of the QBB node of FIG. 2;

FIG. 4 is a schematic block diagram of the centralized DTAG arrangement including a write first-in, first-out (FIFO) queue coupled to a DTAG random access memory array organized into a plurality of DTAG blocks;

FIG. 5 is a schematic block diagram of the write FIFO that may be advantageously used with a DTAG flow control technique of the present invention;

FIG. 6 is a schematic block diagram of flow control logic comprising a plurality of flow control engines adapted to track DTAG activity within a QBB node; and

FIG. 7 is a timing diagram illustrating implementation of the novel DTAG flow control technique with respect to activity within a DTAG block.

### DETAILED DESCRIPTION OF AN ILLUSTRATIVE EMBODIMENT

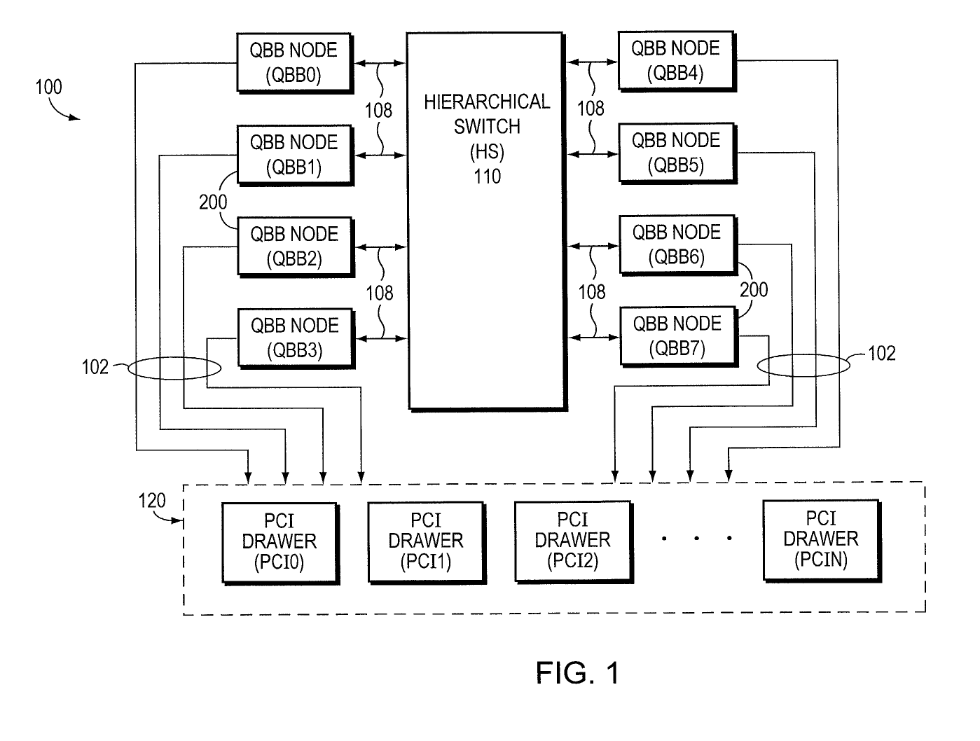

FIG. 1 is a schematic block diagram of a modular, symmetric multiprocessing (SMP) system 100 having a plurality of nodes interconnected by a hierarchical switch (HS) 110. The SMP system further includes an input/output (I/O) subsystem 120 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising a plurality of processors, a plurality of memory modules, an I/O port (IOP) and a global port (GP) interconnected by a local switch. Each memory module may be shared among the processors of a node and, further, among the processors of other QBB nodes configured on the SMP system 100. A fully configured SMP system 100 preferably comprises eight (8) QBB (QBB0-7) nodes, each of which is coupled to the HS 110 by a full-duplex, bi-directional, clock forwarded HS link 108.

Data is transferred between the QBB nodes of the system in the form of packets. In order to provide a distributed shared memory environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

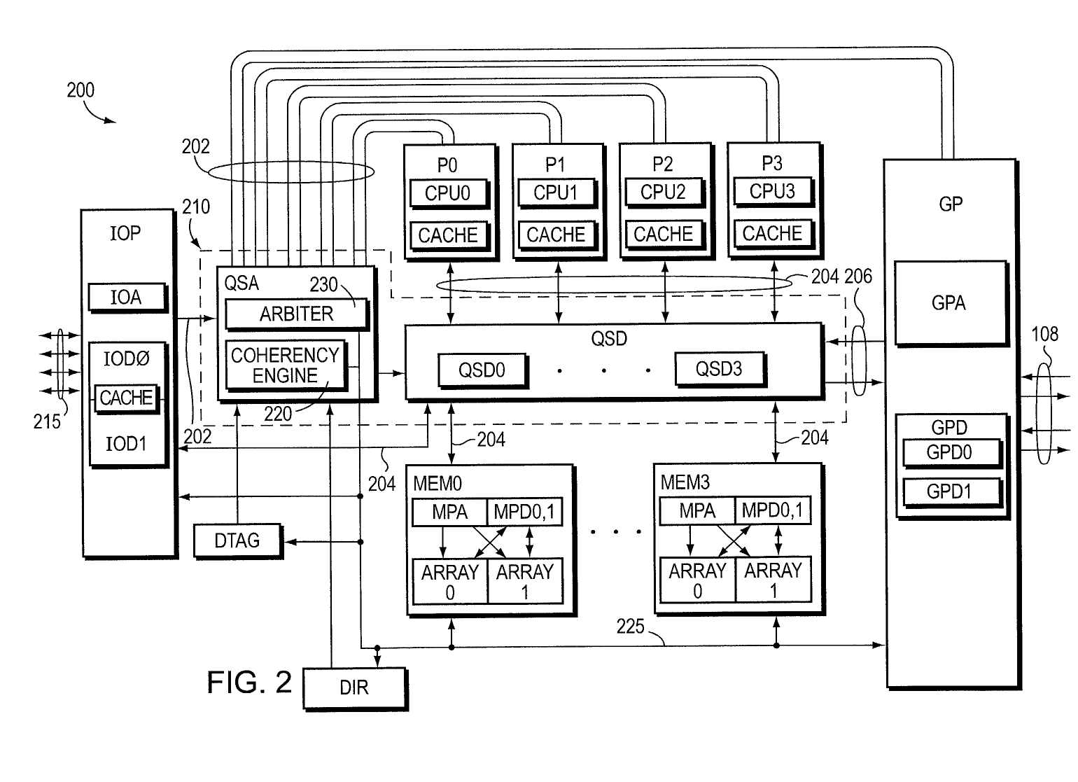

FIG. 2 is a schematic block diagram of a QBB node 200 comprising a plurality of processors (P0-P3) coupled to the IOP, the GP and a plurality of memory modules (MEMO-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system 100 (FIG. 1), data is transferred among the components or “agents” of the QBB node 200 in the form of packets. As used herein, the term “system” refers to all components of the QBB node 200 excluding the processors and IOP.

Each processor is a modem processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation, although other types of processor chips may be advantageously used. The load/store instructions executed by the processors are issued to the system as memory reference requests, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be used in connection with the principles of the invention. It should be further noted that memory reference requests issued by the processors are preferably directed to a 64-byte cache line granularity. Since the IOP and processors may update data in their private caches without updating shared memory, a cache coherence protocol is utilized to maintain data consistency among the caches.

The commands described herein are defined by the Alpha® memory system interface and may be classified into three types: requests, probes, and responses. Requests are commands that are issued by a processor when, as a result of executing a load or store instruction, it must obtain a copy of data. Requests are also used to gain exclusive ownership to a data item (cache line) from the system. Requests include Read (Rd) commands, Read/Modify (RdMod) commands, Change-to-Dirty (CTD) commands, Victim commands, and Evict commands, the latter of which specify removal of a cache line from a respective cache.

Probes are commands issued by the system to one or more processors requesting data and/or cache tag status updates. Probes include Forwarded Read (Frd) commands, Forwarded Read Modify (FRdMod) commands and Invalidate (Inval) commands. When a processor P issues a request to the system, the system may issue one or more probes (via probe packets) to other processors. For example if P requests a copy of a cache line (a Rd request), the system sends a Frd probe to the owner processor (if any). If P requests exclusive ownership of a cache line (a CTD request), the system sends Inval probes to one or more processors having copies of the cache line.

Moreover, if P requests both a copy of the cache line as well as exclusive ownership of the cache line (a RdMod request) the system sends a FRdMod probe to a processor currently storing a “dirty” copy of a cache line of data. In this context, a dirty copy of a cache line represents the most up-to-date version of the corresponding cache line or data block. In response to the FRdMod probe, the dirty copy of the cache line is returned to the system. A FRdMod probe is also issued by the system to a processor storing a dirty copy of a cache line. In response to the FRdMod probe, the dirty cache line is returned to the system and the dirty copy stored in the cache is invalidated. An Inval probe may be issued by the system to a processor storing a copy of the cache line in its cache when the cache line is to be updated by another processor.

Responses are commands from the system to processors and/or the IOP that carry the data requested by the processor or an acknowledgment corresponding to a request. For Rd and RdMod requests, the responses are Fill and FillMod responses, respectively, each of which carries the requested data. For a CTD request, the response is a CTD-Success (Ack) or CTD-Failure (Nack) response, indicating success or failure of the CTD, whereas for a Victim request, the response is a Victim-Release response.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSDO-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IOD0-1) ASICs that collectively provide an I/O port interface from the I/O subsystem to the QBB node. Specifically, the IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS via a set of unidirectional, clock forwarded address and data HS links 108.

The SMP system 100 maintains interprocessor communication through the use of at least one ordered channel of transactions and a hierarchy of ordering points. An ordered channel is defined as a buffered, interconnected and uniquely flow-controlled path through the system that is used to enforce an order of requests issued from and received by the QBB nodes in accordance with an ordering protocol. For the embodiment described herein, the ordered channel is also preferably a “virtual” channel. A virtual channel is defined as an independently flow-controlled channel of transaction packets that shares common physical interconnect link and/or buffering resources with other virtual channels of the system. The transactions are grouped by type and mapped to the various virtual channels to, among other things, avoid system deadlock. Rather than employing separate links for each type of transaction packet forwarded through the system, the virtual channels are used to segregate that traffic over a common set of physical links. Notably, the virtual channels comprise address/command paths and their associated data paths over the links.

In the illustrative embodiment, the SMP system maps the transaction packets into five (5) virtual channels that are preferably implemented through the use of queues. A QIO channel accommodates processor command packet requests for programmed input/output (PIO) read and write transactions, including CSR transactions, to I/O address space. A QO channel carries processor command packet requests for memory space read transactions, while a Q0Vic channel carries processor command packet requests for memory space write transactions. A Q1 channel accommodates command response and probe packets directed to ordered responses for QIO, Q0 and Q0Vic requests and, lastly, a Q2 channel carries command response packets directed to unordered responses for QIO, Q0 and Q0Vic request.

Each packet includes a type field identifying the type of packet and, thus, the virtual channel over which the packet travels. For example, command packets travel over Q0 virtual channels, whereas command probe packets (such as FwdRds, Invals and SFills) travel over Q1 virtual channels and command response packets (such as Fills) travel along Q2 virtual channels. Each type of packet is allowed to propagate over only one virtual channel; however, a virtual channel (such as Q0) may accommodate various types of packets. Moreover, it is acceptable for a higher-level channel (e.g., Q2) to stop a lower-level channel (e.g., Q1) from issuing requests/probes when implementing flow control; however, it is unacceptable for a lower-level channel to stop a higher-level channel since that would create a deadlock situation.

A plurality of shared data structures are provided for capturing and maintaining status information corresponding to the states of data used by the nodes of the system. One of these structures is configured as a duplicate tag store (DTAG) that cooperates with the individual caches of the system to define the coherence protocol states of data in the QBB node. The other structure is configured as a directory (DIR) to administer the distributed shared memory environment including the other QBB nodes in the system. The DTAG and DIR interface with the GP to provide coherent communication between the QBB nodes coupled to the HS 110. The protocol states of the DTAG and DIR are further managed by a coherency engine 220 of the QSA that interacts with these structures to maintain coherency of cache lines in the SMP system 100.

Although the DTAG and DIR store data for the entire system coherence protocol, the DTAG captures the state for the QBB node coherence protocol, while the DIR captures a coarse protocol state for the SMP system protocol. That is, the DTAG functions as a “short-cut” mechanism for commands at the “home” QBB node, as a refinement mechanism for the coarse state stored in the DIR at “target” nodes in the system, and as an “active transaction” bookkeeping mechanism for its associated processors. In particular, the DTAG functions as a short-cut for Q0 memory requests to determine their coherency state as they are issued to the local memory. It functions as a refinement mechanism for Q1 probes, such as invalidates, which are distributed across the system on a per-QBB basis, but must eventually be delivered to a specific subset of processors within the targeted QBBs. Finally, it functions as a bookkeeping mechanism, in case where Q1 and Q2 commands are required for a given transaction, allowing the system to determine when both the Q1 and Q2 components for a given transaction have completed.

The DTAG, DIR, coherency engine 220, IOP, GP and memory modules are interconnected by a logical bus, hereinafter referred to as an Arb bus 225. Memory and I/O reference requests issued by the processors are routed by an arbiter 230 of the QSA over the Arb bus 225, which functions as a local ordering point of the QBB node 200. The coherency engine 220 and arbiter 230 are preferably implemented as a plurality of hardware registers and combinational logic configured to produce sequential logic circuits, such as state machines. It should be noted, however, that other configurations of the coherency engine 220, arbiter 230 and shared data structures may be advantageously used herein.

Specifically, the DTAG is a coherency store comprising a plurality of entries, each of which stores a cache block state of a corresponding entry of a cache associated with each processor of the QBB node 200. Whereas the DTAG maintains data coherency based on states of cache blocks located on processors of the system, the DIR maintains coherency based on the states of memory blocks located in the main memory of the system. Thus, for each block of data in memory, there is a corresponding entry (or “directory word”) in the DIR that indicates the coherency status/state of that memory block in the system (e.g., where the memory block is located and the state of that memory block).

Cache coherency is a mechanism used to determine the location of a most current, up-to-date copy of a data item within the SMP system 100. Common cache coherency policies include a “snoop-based” policy and a directory-based cache coherency policy. A snoop-based policy typically utilizes a data structure, such as the DTAG, for comparing a reference issued over the Arb bus with every entry of a cache associated with each processor in the system. A directory-based coherency system, however, utilizes a data structure such as the DIR.

Since the DIR comprises a directory word associated with each block of data in the memory, a disadvantage of the directory-based policy is that the size of the directory increases with the size of the memory. In the illustrative embodiment described herein, the modular SMP system 100 has a total memory capacity of 256 GB of memory; this translates to each QBB node having a maximum memory capacity of 32 GB. For such a system, the DIR requires 500 million entries to accommodate the memory associated with each QBB node. Yet the cache associated with each processor comprises 4 MB of cache memory which translates to 64 K cache entries per processor or 256 K entries per QBB node.

Thus, it is apparent from a storage perspective that a DTAG-based coherency policy is more efficient than a DIR-based policy. However, the snooping foundation of the DTAG policy is not efficiently implemented in a modular system having a plurality of QBB nodes interconnected by an HS. Therefore, in the illustrative embodiment described herein, the cache coherency policy preferably assumes an abbreviated DIR approach that employs a centralized DTAG arrangement as a shortcut and refinement mechanism.

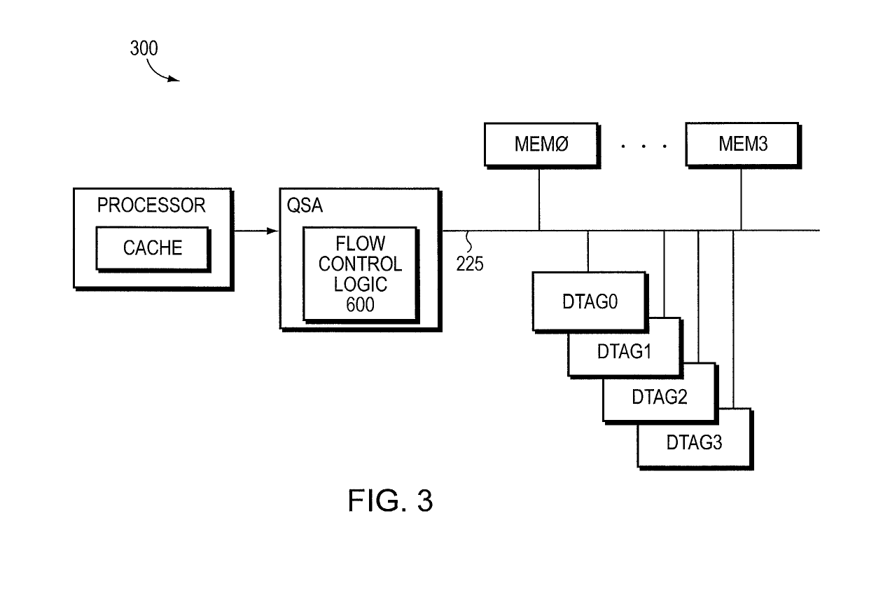

FIG. 3 is a schematic block diagram illustrating the interaction 300 between the local switch (e.g., QSA), memories and centralized DTAG arrangement. The QSA receives Q0 command requests from various remote and local processors. The QSA also receives Q1 and Q2 command requests from various other memory/DIR/DTAG coherency pipelines. The QSA directs all of these requests to the Arb bus 225 via arbiter 230 (FIG. 2) which serializes references to both the memory and centralized DTAG arrangements. As the QSA issues serialized command requests to Arb bus 225, it also provides copies of the command requests to flow control logic 600. The flow control logic 600 (e.g., a plurality of flow control engines) keeps track of the specific types of references issued over the Arb bus to the memory. As described herein, these flow control engines preferably include flow control counters used to count the specific types of references issued over the Arb bus 225 to the memory and to count the number of references issued to each DTAG.

In the illustrative embodiment, the centralized DTAG arrangement is organized in a manner that is generally similar to the memory. That is, there are four (4) DTAG modules (DTAG0-3) on each QBB node 200 of the SMP system 100, wherein each DTAG module is preferably organized into four (4) blocks. Each memory module MEM0-3, on the other hand, comprises two memory arrays, each of which comprises four memory banks for a total of eight (8) banks per memory module. Accordingly, there are thirty-two (32) banks of memory in a QBB node and there are sixteen (16) blocks of DTAG store, wherein each DTAG block maps to two (2) interleaved memory banks.

An appropriate DTAG block is activated in response to a memory reference request issued over the Arb bus 225 in order to retrieve the coherency information associated with the particular memory data block addressed by the referenced request. When a reference is issued over the Arb bus, each DTAG module examines the command (address) to determine if the requested address is contained on that module; if not, it drops the request. The DTAG module that corresponds to the bank referenced by the memory reference request processes that request in order to retrieve the cache coherency information pertaining to the requested data block.

Broadly stated, the DTAG performs a read operation to its appropriate block and location to retrieve the current coherency state of the referenced data block. The coherency state information includes an indication of the current owner of the data block, whether the data is “dirty” and whether the data block is located in memory or in another processor's cache. The retrieved coherency state information is then provided to a “master” DTAG module (e.g., DTAGO) that, in turn, provides a response from the DTAG to the QSA. The DTAG response comprises the current state of the requested data block, such as whether the data block is valid in any of the four processor caches on the QBB node. Thereafter, the next state of the data block is determined, in part, by the memory reference request issued over the Arb bus and this next state information is loaded into the DTAG block and location via a write operation. Thus, both a read operation and a write operation may be performed in the DTAG for each memory reference request issued over the Arb bus 225.

In conventional distributed DTAG implementations, each processor may have its own DTAG that keeps track of only the activity within that processor's cache. Although the DTAG “snoops” the system bus over which other processors and DTAGs are coupled, the DTAG is only interested in memory reference requests that affect its associated processor. In contrast, the centralized DTAG arrangement maintains information about data blocks that may be resident in any of the processors' caches in the QBB node 200 (FIG. 2). This arrangement provides substantial performance enhancements such as the elimination of inter-DTAG communication for purposes of generating a response to a processor indicating the current state of a requested data block. In addition, the arrangement further enhances performance by reducing latencies associated with the generation of a response by eliminating the physical distances and proximities between DTAGs and thus intercommunication mechanism, as in the prior art.

Each Q0, Q1 or Q2 reference issued to the Arb bus 225 may require one or two DTAG operations. Specifically, all requests require an initial DTAG read operation to determine the current state of the cache locations addressed by the request. Depending on the state of the addressed cache locations and the request type, a write operation may also be required to modify the state of the addressed cache locations. If, for example, a Q1 Inval request for block x were issued to Arb bus 225 and the associated DTAG read indicated that one or more of the processors local to Arb bus 225 had a copy of memory block x in their cache, then a DTAG write would be required to update all DTAG entries associated copies of memory block x to the invalid state. Since the QSA, DTAG, DIR and GP are all fixed length coherency pipelines, it is critical for DTAG read data to be retrieved in with a fixed timing relationship relative to the issuance of a reference on Arb bus 225. To provide this guarantee, the DTAG is designed such that read operations are granted higher priority than write transactions. As a result, the DTAG provides a logic structure to temporarily and coherently queue write operations that are preempted by read operations. The write operations are queued in this structure until no read operations are pending, at which time, they are retired.

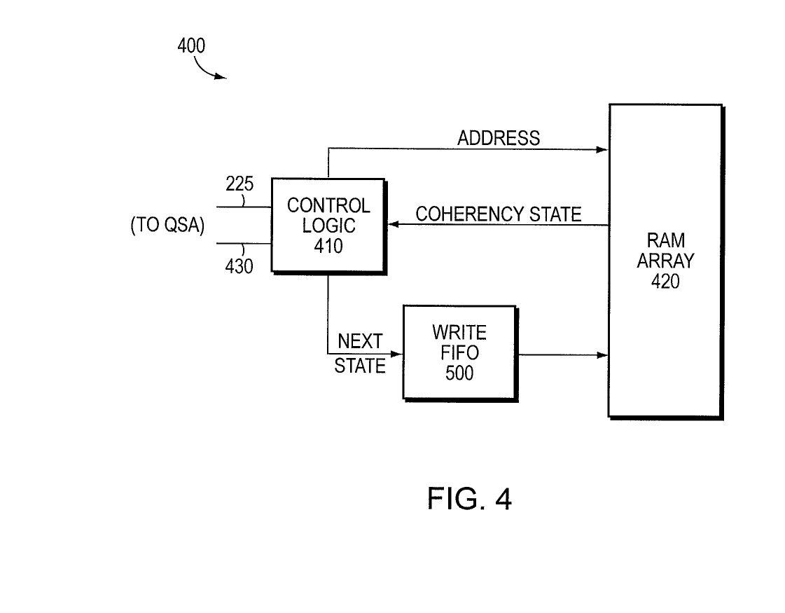

FIG. 4 is a schematic block diagram of the DTAG 400 including control logic 410 coupled to a random access memory (RAM) array 420 and a write first-in, first-out (FIFO) queue 500. The write FIFO 500 has a limited size (number of entries) and the flow control logic 600 (FIG. 3) in the QSA keeps track of when these entries may be occupied to avoid overflowing the FIFO 500. The RAM array 420 stores the cache coherency state information for data blocks within the respective QBB node. The control logic 410 retrieves the cache coherency state information from the array for a data block addressed by a memory reference request and makes a determination as to the current state of the data block, along with the next state of that data block. The control logic 410 further includes a plurality of logic functions organized as an address pipeline that propagates address request information to ensure that the information is available within the control logic 410 during execution of the read operation to the DTAG block.

The DTAG RAM array 420 is partitioned in a manner such that it stores information for all processors on a QBB node. That is, the DTAG RAMs are partitioned based on the partitioning of the memory banks and the presence of processors and caches in a QBB node. Although the organization of the centralized DTAG is generally more complex than the prior art, this organization provides increased bandwidth to enable a high performance SMP system. Specifically, the RAM array is preferably a single-ported (1-port) RAM store that enables only a read operation or a write operation to occur at a time. That is, unlike a dual-ported RAM, the single-ported RAM cannot accommodate read and write operations simultaneously. Since more storage capacity is available in a single-ported RAM than is available in a dual-ported RAM, use of a 1-port RAM store in the SMP system allows use of larger caches associated with the processors.

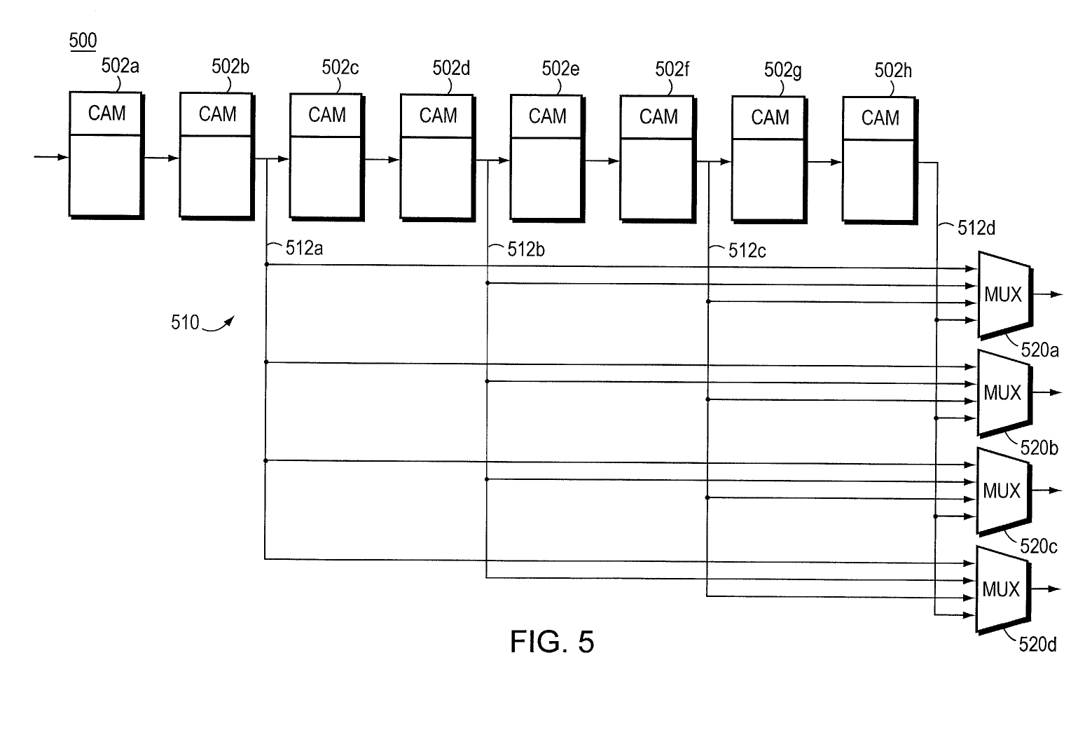

FIG. 5 is a schematic block diagram of the write FIFO 500 comprising a plurality of (e.g., 8) stages or entries 502a-h. Each stage/entry 502 is organized as a content addressable memory (CAM) to enable comparison of a current address and command request to a pending address and command request in the FIFO. That is, when a read operation is performed in the DTAG to determine the coherency state of a requested data block, the CAMs may be scanned to determine whether the address of the requested data block matches within a stage 502 of the write FIFO 500. If so, the current state of the requested data is retrieved from that stage. The write FIFO 500 also includes a bypass mechanism 510 having a plurality of bypass paths. Each bypass path 512a-c is available every two stages 502 of the write FIFO depending upon the impending/queued number of updates (write operations) in the FIFO. Each path 512a-c (along with a last path 512d) is coupled to one of a plurality of inputs of a series of bypass multiplexers 520a-d. An output of each multiplexer is coupled to the DTAG RAM array 420.

As noted, each reference request issued over the Arb bus 225 by the QSA generates a read operation and, possibly, a write operation in the DTAG 400. As also noted, because the DTAG RAM array 420 is single-ported, only a read or a write operation can be performed at a time; that is, the RAM cannot accommodate both read and write operations simultaneously. Furthermore, the read operations have priority over the write operations in order to quickly and efficiently retrieve the coherency state information of the requested data block. When a new memory reference request is issued over the Arb bus, the read operation in the DTAG has priority even if there are many write (update) operations “queued” in the write FIFO 500. Accordingly, there is a possibility that the write FIFO may overflow.

The present invention comprises a flow control technique for preventing overflow of the write FIFO 500. To that end, the novel flow control technique takes advantage of the properties of the virtual channels in the SMP system. As described herein, the flow control technique limits the flow of Q0 commands over the Arb bus 225 from the QSA when the write FIFO 500 in the DTAG may overflow. Notably, the issuance of Q1 and Q2 commands over the Arb bus 225 is not suppressed for purposes of the flow control because they need to complete in order for the system to progress and to avoid impeding progress of the SMP system.

Referring again to FIG. 3, QSA via arbiter 230 (FIG. 2) issues Q1 and Q0 requests to Arb bus 225 according to a series of arbitration rules. These rules dictate, inter alia, that at most two Q0 references may be issued to a given memory bank (and corresponding DTAG block) in an 18 cycle time period. In addition, Q1 and Q2 references are issued at a higher priority than Q0 references and Q1 and Q2 requests must be issued to Arb bus 225 at a rate that matches their arrival rate at a given QBB, where the worst case arrival rate is one Q1 or Q2 request every other cycle. In nominal traffic patterns, a given stream of Q1 references arriving at a QBB will address a variety of DTAG blocks. In certain pathological cases, however, each of seven remote Arb busses can, according to the aforementioned rules, generate up to two Q1 references for the same DTAG block every 18 cycles. In such cases, it is theoretically possible to produce a stream of Q1 requests of infinite length, arriving at a QBB at the maximum arrival rate wherein each request in the stream targets the same DTAG block. While in practice infinite streams of Q1 and Q2 packets to the same DTAG block do not occur, streams of hundreds of Q1 and Q2 packets that all address the same DTAG block are a distinct possibility. During these streams, the Q1 and Q2 commands can generate up to 18 DTAG operations (e.g., 9 reads and 9 writes) every 18 cycles. If the QSA issues the Q0 commands such that they interleave with the Q1 and Q2 commands in the stream, it is then possible to generate up to 22 DTAG operations (e.g., 9 Q1/Q2 reads, 2 Q0 reads, 9 Q1/Q2 writes and 2 Q0 reads) every 18 cycles. This is 4 more operations every 18 cycles than a single ported DTAG block can service in the same time period.

Since DTAG reads are prioritized over writes, any excess DTAG operations generated during such a stream of Q1 and Q2 references to a common DTAG block will necessarily be writes. These writes will be stored in the DTAG's write FIFO 500. While the Q1 and Q2 stream continues the individual writes in the write FIFO will make progress to completion in the time available between DTAG reads. As excess writes continue to be generated, however, the total number of FIFO entries occupied at a given time will increase. Thus, if Q0, Q1 and Q2 references are allowed to be issued unabated such that more than 18 DTAG operations are required within each 18 cycle time window, then the DTAG write FIFO 500 will eventually overflow.

As described above, the present invention comprises a flow control technique for preventing the overflow of the DTAG write FIFO 500. This novel flow control technique prevents the overflow of the write FIFO, while in particular limiting the class of transactions that it impedes to the smallest possible subset of system transactions. Specifically, instead of impeding the progress of Q1, Q2 or the whole Q0 virtual channels, the technique impedes the progress of only those Q0 references that address the same DTAG block. This allows the critical Q1 and Q2 virtual channels, as well as all other transactions within the Q0 virtual channel to continue to make progress until the pathological stream of Q1 and Q2 references directed to the same DTAG block ends. It is interesting to note that even when this novel flow control mechanism is active, as long as the stream of Q1 and Q2 references continues, the number of entries in the write FIFO 500 may not decrease. This is because the Q1/Q2 stream can consume all of the DTAG block's operational bandwidth (i.e., 18 DTAG operations in 18 cycles). Only when the stream ends and bandwidth becomes available in the DTAG block does the write FIFO 500 empty.

In the illustrative embodiment, the flow control logic 600 (FIG. 3) of the QSA keeps track of the types of requests issued to the Arb bus 225 and, based on those requests, determines if a DTAG write FIFO 500 is likely to overflow. Since flow control logic 600 does not have access to the DTAG state associated with a given request, it cannot determine to a certainty the state of a write FIFO. Specifically, it cannot determine which requests will require both DTAG read and write operations and which requests will require only read operations. Instead, flow control logic 600 is designed such that it tracks the state of write FIFOs assuming that every request requires both a read and a write operation. This characteristic of the flow control logic 600 makes it conservative, but correct regardless of the write FIFO's true state.

Flow control logic 600 calculates the approximate state of a DTAG write FIFO 500 by means of a set of counters. These counters are used to track the occurrences where entries are added to the write FIFO 500 and occurrences where entries may be removed from the write FIFO. The algorithm presumes that the only event that can cause persistent entries to be placed in the write FIFO 500 is the issuance of a Q0 request during a pathological Q1/Q2 stream. Each issuance of a Q0 command during a Q1/Q2 stream may add two entries to the write FIFO: one corresponding to the Q1/Q2 write displaced by its read and another corresponding to its own write. Thus, flow control logic 600 comprises a counter that is incremented based upon the issuance of Q0 commands. When this counter reaches a programmable threshold, flow control logic 600 asserts a flow control signal and discontinues or suspends issuance of additional Q0 references to the affected DTAG block. Flow control logic 600 also includes a mechanism that detects “gaps” in the stream of Q1 and Q2 requests. A gap is defined as a cycle on Arb bus 225 where a Q1 or Q2 request would have been issued had a Q1/Q2 stream been proceeding at full bandwidth, but in which no Q1 or Q2 request was in fact issued. A gap represents a opportunity to retire a persistent write from the write FIFO 500. Each gap detected in a Q1/Q2 stream will therefore cause the aforementioned flow control counter to decrement. If a flow control signal is asserted, and enough “gaps” have been detected such that the associated flow control counter is decremented below the programmable threshold, then the flow control signal is deasserted and Q0 requests may again be issued to the associated DTAG block via the Arb bus 225.

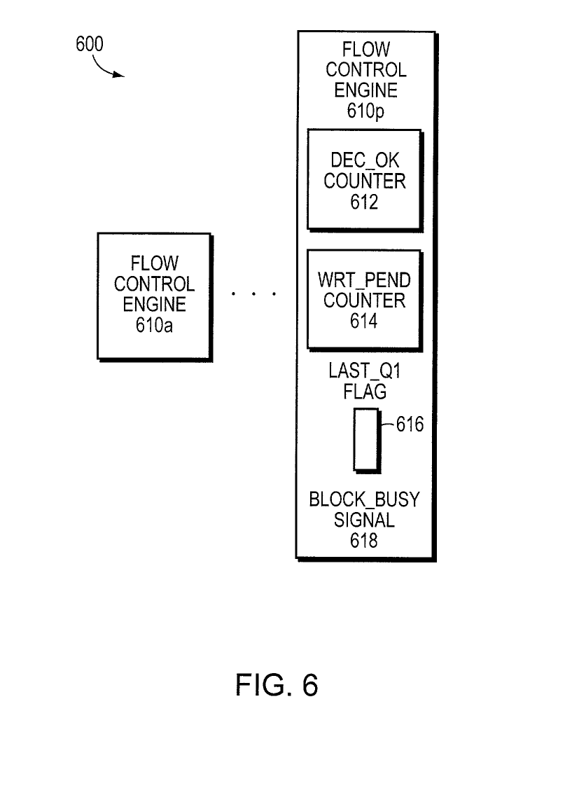

FIG. 6 is a schematic block diagram of the flow control logic 600 comprising a plurality of (e.g., 16) independent, flow control engines 610a-p adapted to track DTAG activity within a QBB node. Each flow control engine 610a-p comprises conventional combinational logic circuitry configured as a plurality of counters, including a 3-bit decrement ok (dec_ok) counter 612 and a 3-bit write pending (wrt_pend) counter 614, as well as a last_cycle_q1 flag 616 and a block_busy signal or flag 618. A flow control engine 610 is provided for each DTAG block and is coupled to the main arbiter 230 of the QSA primarily because it is the arbiter 230 that determines whether a reference should be issued over the Arb bus 225. The flag, signal and counters maintained for each DTAG block reflect the activity (traffic) that occurs within that corresponding DTAG block. That is, each engine 610 provides the arbiter 230 with a coarse approximation of activity occurring within the respective write FIFOs 500 of the DTAG. As explained above, this approximation is a conservative prediction since not every transaction issued over the Arb bus 225 results in both read and write operations in the DTAG.

According to an aspect of the flow control technique of the present invention, the wrt_pend counter 614 is used to track when entries are or will be added to the associated DTAG write FIFO 500. The dec_ok counter 612 is used to indicate when the entries are presumed to have actually been added to the FIFO, and are thus eligible to be removed during the next “gap”. For a Q0 reference, for example, its read reference will immediately cause a persistent entry to be added to the write FIFO 500 if it conflicts with a Q1 request write and will eventually add another persistent entry to the write FIFO if it requires a write itself. Thus, a Q0 reference should, upon issue, cause the wrt_Pend counter 614 to increment by 2 and the dec_ok counter 612 to increment by 1. Some number of cycles later, at the time the Q0 reference's own write may be generated, the dec_ok counter 612 should again be incremented by 1.

First, the dec_ok and wrt_pend counters 612, 614 are initialized (reset) to 0. Each time a Q0 command is issued over the Arb bus 225 that references the DTAG block, the dec_ok counter 612 is incremented by 1 and the wrt_pend counter 614 is incremented by 2. As described above, the dec_ok counter is also incremented when a write operation is loaded into the write FIFO 500 since that operation initiates an access to the RAMs. In other words, the dec_ok counter is incremented whenever the Q0 command is issued over the Arb bus 225 and is again incremented 6 cycles later when the write operation reaches the write FIFO 500.

The block_busy signal 618 and last_cycle_q1 flag 616 cooperate to identify “gaps” in a pathological Q1/Q2 stream, which allow, depending on the state of the dec_ok counter 612, the dec_ok and wrt_pend counters 612, 614 to be decremented. Specifically, in each cycle that flow control logic 600 detects a Q0, Q1 or Q2 request on Arb bus 225, it asserts the block_busy signal 618. Similarly, in the cycle after each cycle in which the logic 600 detects a Q1 or Q2 request on the Arb bus 225, logic 600 sets the last_cycle_q1 flag 616. The assertion of signal 618 and flag 616 persists for a single cycle. Any cycle in which block_busy signal 618 is deasserted indicates that there is no DTAG read associated with that cycle. Similarly, any cycle in which last_cycle q1 flag 616 is deasserted indicates that there is no Q1 or Q2 DTAG write associated with that cycle. Any cycle where both the block_busy signal 618 and last_cycle_q1 flag 616 are deasserted, indicates a cycle in which neither a read nor a Q1/Q2 write is associated. It is, therefore, a cycle available for a Q0 write, i.e. a “gap”.

The states of the block_busy signal 618, last_cycle_q1 flag 616 and dec_ok counter 612 can therefore be combined to determine when a persistent write may be retired from a DTAG write FIFO 500. Block_busy signal 618 and last_cycle_q1 flag 616 together indicate the presence of a “gap” where a write may take place, and the state of the dec_ok counter 612 indicates whether a write is present in the write FIFO 500 to take advantage of the gap. Thus, when the block_busy signal 618 and the last_cycle_q1 flag 616 are both deasserted, and the dec_ok counter is greater than zero, then a write in the write FIFO may be retired and the wrt_pend counter 614 may be decremented.

According to another aspect of the inventive technique, flow control is invoked when the count in the wrt_pend counter 614 exceeds a particular threshold and the dec_ok counter 612 is greater than 0. In the illustrative embodiment, the predetermined threshold of the wrt_pend counter is preferably greater than or equal to six, although the threshold is programmable and may, in fact, assume other values, such as four or eight. Thus, whenever a flow control engine's wrt_pend counter exceeds the programmable threshold, it causes the QSA to discontinue issuance of Q0 commands to the associated DTAG block. Once flow control is invoked, the main arbiter 230 does not issue a Q0 command over the Arb bus to the DTAG block until the count in the wrt_pend counter falls below the threshold (e.g., 6).

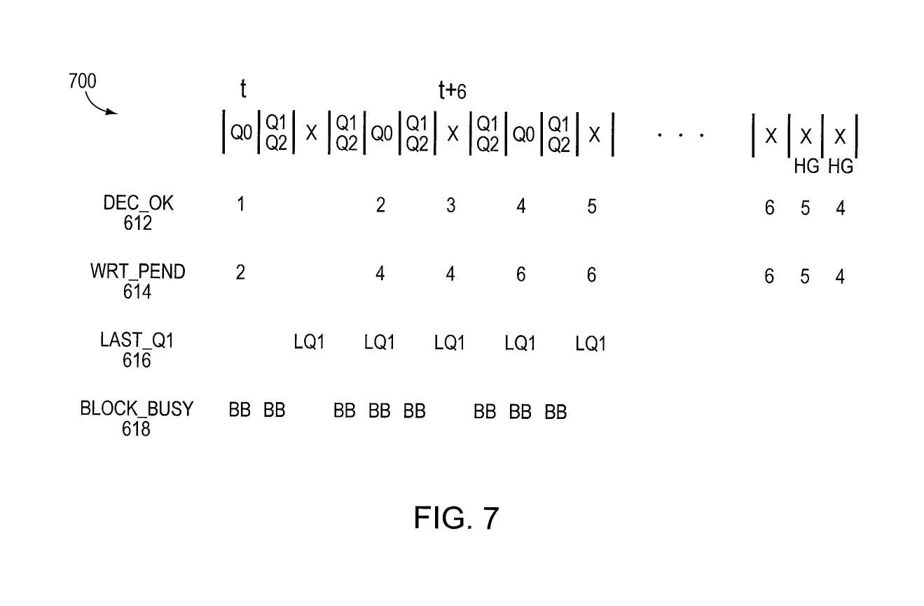

FIG. 7 is a timing diagram 700 illustrating implementation of the novel DTAG flow control technique with respect to activity within a DTAG block. The timing diagram illustrates a plurality of sequential cycles occurring over the Arb bus 225. The total bandwidth of the DTAG is sufficient to accommodate issuance of a Q1 or Q2 command every other cycle over the Arb bus. Any activity beyond that will cause an additional write entry to be queued in the write FIFO 500 because there is not sufficient bandwidth in the DTAG to accommodate such activity. Adding enough additional entries to the write FIFO 500 will cause it to fill up and eventually overflow. In other words, an overflow condition with respect to the write FIFO only occurs when there is substantial activity directed to a particular DTAG block. Thus, a goal of the present invention is to detect the occurrence of such additional activity to thereby avoid overflowing the write FIFO 500.

For example, assume there is a continuous flow of Q1/Q2 commands every other cycle over the Arb bus 225. Assume also that Q0 commands are issued in between at least some of these Q1/Q2 cycles. If memory reference requests are directed to multiple DTAGs, there is no need to flow control the issuance of the Q0 commands to those DTAGs. The condition that causes the write FIFO 500 in a particular DTAG to overflow is a continuous stream of Q1 and Q2 commands, not Q0 commands, directed to that DTAG.

For every command issued over the Arb bus 225, there is a read operation issued in the DTAG to determine the current coherency state of the requested data block and, if an update is required, there is a subsequent write operation issued to the DTAG array 420. The write operation is presented to the write FIFO approximately 6 cycles later. Therefore, if a command that is issued over the Arb bus at time t, the write operation is queued into the write FIFO at time t+6. If there are no pending updates in the write FIFO 500, the write operation flows directly to the “head” of the FIFO (via the bypass 10 mechanism 510) and is retired. Otherwise, the write operation is blocked within the FIFO.

The last cycles of the timing diagram 700 denote half-gap (HG) cycles wherein there is no activity on the Arb bus directed to the DTAG block. Since neither the last_cycle_q1 (LQ1) flag nor the block_busy (BB) signal is asserted during those latter cycles, the counters 612, 614 are decremented by 1 to provide the DTAG logic an opportunity to retire pending write operations. For example, assume that both the dec_ok and wrt_pend counters 612, 614 eventually attain a value of 6. As a result of the first half-gap condition arising, both counters are decremented by one such that the values of those counters become 5. As a result of the next half-gap condition, the counters are again decremented by 1 and their values now become 4. Once the value of the wrt_pend counter 614 falls below the predetermined threshold, even though the value of the dec_ok counter 612 may be greater than 0, flow control is suppressed and Q0 commands may again be issued by the QSA over the Arb bus 225 to the DTAG block.

An advantage of the invention is that Q1 and Q2 commands are never suppressed as a result of the flow control technique. That is, the inventive flow control technique never stops higher order channels, which must always keep moving, and only impacts the lowest order channel. In addition, flow control only impacts one subset (e.g., an inter-leaved unit) of the DTAG and is invoked for the interleaved unit (e.g., a DTAG block) only when the rare condition described herein, i.e., a continuous flow of Q1/Q2 and Q0 commands issued to the same DTAG block, occurs. Once flow control is invoked, the QSA can nevertheless continue to issue Q0 commands directed to different DTAG blocks.

The foregoing description has been directed to specific embodiments of the present invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. In a multiprocessor computer system defining two or more channels for transporting packets among system components during system cycles, a flow control system for preventing overflow of a system component configured to process at least two classes of packets, the flow control system comprising:
a counter incremented in response to a packet of any class being issued to the interleaved component; and
flow control logic configured to suspend issuance of packets corresponding to a first class to the component in response to the counter reaching a predefined threshold.

2. The flow control system of claim 1 wherein the packet classes are hierarchically ordered between a highest class and a lowest class.

3. The flow control system of claim 2 wherein packets corresponding to the lowest class are suspended upon the counter reaching the predefined threshold, while packets corresponding to the remaining higher classes continue to be issued to the component.

4. The flow control system of claim 3 further comprising:
a last response flag; and
a component busy signal that is moveable between an asserted and a deasserted condition, wherein
in response to issuance of a packet of any class to the component during a given cycle, the component busy signal is moved to the asserted condition during the given cycle,
in response to issuance of a packet corresponding to a second class to the component during a given cycle, the last response flag is asserted during the cycle immediately following the given cycle in which the packet of the second class was issued, and
in response to both the last response flag and the component busy signal being deasserted, the counter is decremented.

5. The flow control system of claim 4 further comprising a second counter incremented a predefined number of cycles following the issuance of each packet corresponding to the first class.

6. The flow control system of claim 5 wherein the second counter is incremented by 1 and the first counter is incremented by 2.

7. The flow control system of claim 6 wherein when the first counter drops below the predetermined threshold, issuance of packets corresponding to the first class resumes.

8. The flow control system of claim 7 wherein packets corresponding to the first class are suspended provided that the second counter is greater than 0.

9. The flow control system of claim 8 wherein the component is a write first-in-first-out (FIFO) queue of an interleaved duplicate cache tag store (DTAG), the write FIFO queue having a fixed number of entries for storing cache coherency information to be written to the DTAG.

10. The flow control system of claim 9 wherein the write FIFO queue comprises a plurality of content addressable memory (CAM) units, each CAM unit having a plurality of cells for storing the cache coherency information.

11. The flow control system of claim 10 further comprising a plurality of flow control engines, each flow control engine comprising:
a decrement ok (dec_ok) counter;
a write pending (wrt_pend) counter;
a last response flag; and
a component busy signal that is moveable between an asserted and a deasserted condition, wherein the multiprocessor computer system includes a plurality of DTAGs, and
each flow control engine associated with and configured to control the issuance of packets corresponding to the first class directed to a respective DTAG.

12. The flow control system of claim 11 wherein the first class has a lower priority than the second class.

13. The flow control system of claim 12 wherein the first class corresponds to request packets and the second class corresponds to response packets.

14. In a multiprocessor computer system configured to issue request and response packets during system cycles, a flow control method for preventing overflow of a shared component having a limited number of resources, the flow control method comprising the steps of:
providing a decrement ok (dec_ok) counter;
providing a write pending (wrt_pend) counter;
providing a last response flag;
providing a component busy signal that is moveable between an asserted and a dasserted condition;
incrementing the dec_ok counter and the wrt_pend counter in response to issuance of a request packet;
moving the component busy signal to the asserted condition during a given cycle in which a request or a response packet is issued;
asserting the last response flag during the cycle immediately following a given cycle in which a response packet is issued; and
suspending issuance of request packets when the wrt_pend counter exceeds a predetermined threshold, but continuing issuance of response packets.

15. The method of claim 14 further comprising the step of decrementing the dec_ok and wrt_pend counters when both the last response flag and the component busy signal are deasserted.

16. The method of claim 15 further comprising the step of further incrementing the dec_ok counter a predefined number of cycles following the issuance of a given request packet.

17. The method of claim 16 further comprising the step of resuming issuance of request packets when the wrt_pend counter drops below the predetermined threshold.

18. The method of claim 17 wherein
the dec_ok counter is incremented by 1,
the wrt_pend counter is incremented by 2, and
the step of suspending request packets further requires that the dec_ok counter be greater than 0.

19. A computer system comprising:
a plurality of processors having private caches, the processors organized into quad building blocks (QBBs) and configured to cause the issuance by the system of packets across two or more channels;
a main memory subsystem disposed at each QBB, each main memory subsystem configured into a plurality of interleaved memory banks having addressable memory blocks;
a duplicate tag store (DTAG) disposed at each QBB, each DTAG having a DTAG array having a plurality of DTAG blocks for storing coherency information associated with the memory blocks buffered at the private caches of the QBB, each DTAG block associated with two or more interleaved memory banks;
a write first-in-first-out (FIFO) queue associated with each DTAG block configured to buffer coherency information to be loaded into the respective DTAG block;
a flow control system for preventing overflow of the write FIFO queues, the flow control system having a flow control engine associated with each DTAG block, each flow control engine comprising:
a decrement ok (dec_ok) counter;
a write pending (wrt_pend) counter;
a last response flag; and
a component busy signal that is moveable between an asserted and a deasserted condition, wherein
in response to issuance of a packet on a first channel to the respective DTAG block, the dec_ok counter and the wrt_pend counters are both incremented,
in response to issuance of a packet on either the first channel or a second channel to the respective DTAG block during a given cycle, the component busy signal is moved to the asserted condition during the given cycle,
in response to issuance of a packet on the second channel to the respective DTAG block during a given cycle, the last response flag is asserted during the cycle immediately following the given cycle in which the second channel packet was issued, and
when the wrt_pend counter exceeds a predetermined threshold, issuance of further packets on the first channel to the write FIFO queue of the respective DTAG block are suspended, but issuance of packets on the second channel to the write FIFO queue continues.
